(19) United States
(12) Patent Application Publication
(10) Pub. No.: US 2008/0178956 A1
(43) Pub. Date: Jul. 31, 2008

(54) Fluid distribution apparatus and method of use thereof

(76) Inventor: Bruce Willingham, Idabel, OK (US)

Correspondence Address: DUNLAP CODDING & ROGERS, P.C., PO BOX 16370, OKLAHOMA CITY, OK, 73113, US

(21) Appl. No.: 11/698,716

(22) Filed: Jan. 26, 2007

(51) Int. Cl. F16L 55/00

(52) U.S. Cl. 138/108; 138/112

(57) ABSTRACT

A fluid distribution apparatus is positioned within an interior passageway of an existing conduit. The conduit is part of a fluid collection system. The fluid distribution apparatus includes at least one stabilizing member and at least one receptacle. The at least one stabilizing member engages at least a portion of a sidewall of a portion of the conduit defining the interior passageway extending through the conduit. The at least one receptacle is supported by the stabilizing member. The at least one receptacle has at least one passageway extending therethrough. The at least one passageway sized and dimensioned to receive at least one pipe while permitting fluid to flow through the interior passageway of the existing conduit.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to an apparatus for distributing fluid and more particularly, but not by way of limitation, to an apparatus for distributing fluid by an existing fluid collection system.

2. Description of the Related Art

Residential, commercial or industrial wastes are typically treated by municipal wastewater treatment facilities. Most municipal sewage and wastewater collection and treatment systems have direct connections between residences and office/industrial buildings and a sewage collection pipeline that feeds into a main pipeline. Typically, the main pipeline enters a sewage treatment facility and the sewage is carried and dispersed into treatment tanks. Collection systems vary depending upon the waste treatment requirements of a community and the type of wastewater treatment system utilized by the community.

Since existing collection lines are an established line of travel or access, the existing collection lines may provide an established line of access for the delivery of other products or services. The system of pipes used for the collection of wastewater may provide a cost-effective vehicle for the delivery of raw water and/or treated wastewater to homes, businesses and industry, thus promoting water conservation and extending the useful life of water treatment plants by separating raw water requirements from treated water requirements, while also reducing the amount of treated wastewater discharged into streams. In addition, the use of existing established lines may also act as a passageway for a variety of other media and services, such as fiber-optic lines, cable, etc. without extensive cost and digging.

To this end, a need exists for an apparatus for distributing fluids by the use of existing collection systems to distribute the fluids to homes, businesses, and industry. It is to such a fluid distribution apparatus that the present invention is directed.

### BRIEF DESCRIPTION OF THE SEVERAL VIEWS OF THE DRAWINGS

FIG. 1 is a cross-sectional view of a fluid distribution apparatus constructed in accordance with the present invention, the fluid distribution apparatus positioned in an existing collection conduit which is part of a wastewater collection system.

FIG. 2 is a cross-sectional view of the fluid distribution apparatus of FIG. 1.

FIG. 3 is a fragmental, elevational view, partially in cross-section, of the fluid distribution apparatus of FIG. 1.

FIG. 4 is a cross-sectional view of another embodiment of a fluid distribution apparatus having a plurality of receptacles constructed in accordance with the present invention.

FIG. 5 is a cross-sectional view of yet another embodiment of a fluid distribution apparatus having a plurality of receptacles constructed in accordance with the present invention.

### DETAILED DESCRIPTION OF THE INVENTION

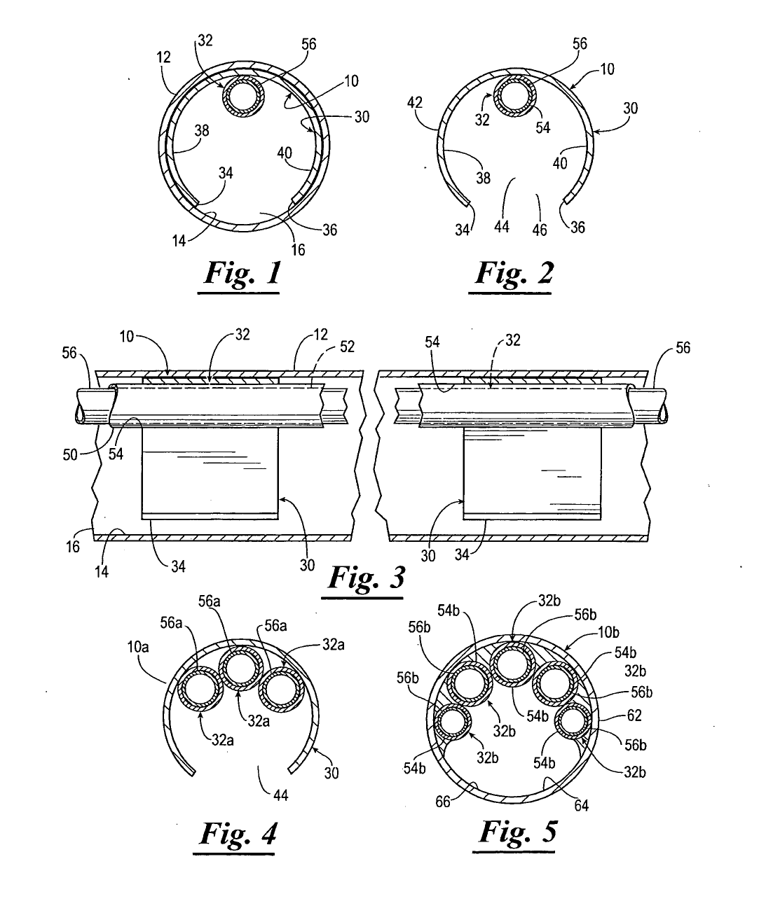

Referring now to the drawings, and more particularly to FIGS. 1 and 3, a fluid distribution apparatus 10 constructed in accordance with the present invention is shown disposed in a conduit 12 of a conventional wastewater treatment collection system (not shown) to distribute other fluids, such as treated wastewater or raw water, to desired locations, such as homes, businesses, and industry. The conduit 12 has a sidewall 14 defining an interior passageway 16 for receiving untreated wastewater. The conduit 12 may be constructed of any material used to transport wastewater, such as cast iron, fiberglass, polyethylene and polyvinylchloride (PVC). The conduit 12 may be any size of conduit provided that the conduit 12 functions in the manner described herein. It should be understood that although the conduit 12 is shown utilizing the fluid distribution apparatus 10, the fluid distribution apparatus 10 is not limited to use with a wastewater treatment system, but may be used with a wide variety of systems and apparatuses which utilize conduit structures for the delivery of a product or service.

As shown in FIGS. 1-3, the fluid distribution apparatus 10 includes at least one stabilizing member 30, and at least one receptacle 32. The stabilizing member 30 has a first end 34, a second end 36, a first sidewall 38, a second sidewall 40, an exterior 42 and an interior 44.

The at least one stabilizing member 30 is disposed in the interior passageway 16 of the conduit 12 to stabilize the fluid distribution apparatus 10 in a stable position within the interior passageway 16 of the conduit 12. It should be understood that the at least one stabilizing member 30 may be sized to frictionally engage the sidewall 14 of the conduit 12. The first and second ends 34 and 36 of the at least one stabilizing member 30 are spatially disposed so that an opening 46 is provided therebetween. The opening 46 enhances compression of the first sidewall 38 and the second sidewall 40 of the at least one stabilizing member 30 toward each other as the fluid distribution apparatus 10 is disposed into the conduit 12. Once positioned in the conduit 12, the first sidewall 38 and the second sidewall 40 of the at least one stabilizing member 30 bias outwardly and frictionally engage the sidewall 14 of the conduit 12. It should be understood that the first sidewall 38 and the second sidewall 40 of the stabilizing member 30 may be adhesively connected to the conduit 12 as well as being frictionally secured to the conduit 12.

The at least one stabilizing member 30 is shown shaped like the interior passageway 16 of the conduit 12. However, it should be understood that the at least one stabilizing member 30 may be formed into any shape so long as the at least one stabilizing member 30 functions to stabilize the at least one receptacle 32 within the interior passageway 16 of the conduit 12. It should also be understood that the diameter of the interior 44 of the at least one stabilizing member 30 may be less than the diameter of the interior passageway 16 of the conduit 12 such that the at least one stabilizing member 30 is sized and dimensioned to be fitted into the conduit 12. The at least one stabilizing member 30 may be constructed from PVC, other polymeric materials such as polyethylene, metals such as steel, copper, titanium, aluminum, or alloys containing these metals, and composite materials which are capable of providing the desired strength and durability for the at least one stabilizing member 30.

The at least one receptacle 32 has a first end 50, a second end 52, and a passageway 54 extending therebetween. The passageway 54 of the at least one receptacle 32 is sized and dimensioned to receive and support at least one pipe 56 having a smaller diameter than that of the diameter of the passageway 54 of the at least one receptacle 32 while permitting fluid to flow through the interior passageway 16 of the existing conduit 12. It should be understood that the at least one receptacle 32 may be any size provided that the fluid distribution apparatus 10 functions as described herein.

Although the at least one receptacle 32 is shown herein to have a substantially cylindrical shape, it will be appreciated that the at least one receptacle 32 may be constructed in a variety of different shapes so long as the at least one receptacle 32 can accommodate at least one pipe 56 and function in accordance with the present invention. Suitable materials for construction of the at least one receptacle 32 include polymeric materials such as PVC, metals such as aluminum, copper, steel, titanium, or alloys containing these metals, and composite materials which are capable of providing the desired strength and durability of the at least one receptacle 32. The material chosen will be compatible with the material of the conduit so as to prevent static electricity or some other undesired outcome.

The at least one receptacle 32 is supported by the interior 44 of the at least one stabilizing member 30. The at least one receptacle 32 may be adhesively connected to the at least one stabilizing member 30 or may be secured to the at least one stabilizing member 30 by any various methods known in the art for securing one thing to another. The at least one receptacle 32 may also be integrally formed with the at least one stabilizing member 30.

A portion of the fluid distribution apparatus 10 for the conduit 12 may be provided with a porous material so as to provide indication of a break in the conduit 12. Additionally, the fluid distribution apparatus 10 or the conduit 12 may be provided with a monitoring apparatus (not shown) for detecting the leakage of fluid from the fluid distribution apparatus 10 or the conduit 12. It should be understood that any conventional apparatus or method for leak detection location may be utilized with the present invention. Further, any conventional apparatus or method for monitoring the conditions (pressure, temperature, etc.) of the fluid distribution apparatus 10 or the conduit 12 may be utilized with the present invention. Since such apparatuses and methods of using same are well known in the art, no further comments or description concerning such apparatuses or methods is believed necessary in order to enable one skilled in the art to fully understand and practice the invention disclosed herein.

Referring to FIG. 4, another embodiment of a fluid distribution apparatus 10a is shown that is substantially the same as the fluid distribution apparatus 10 except that a plurality of receptacles 32a are supported by the interior 44 of the at least one stabilizing member 30. The plurality of receptacles 32a are operably connected to one another and to the interior 44 of the at least one stabilizing member 30. A plurality of pipes 56a are disposed into the receptacles 32a. It should be understood that the plurality of receptacles 32a may be the same or of varying diameters for receiving pipes of the same or varying diameters. The various pipes 56a may provide passage for various fluids, such as raw water, treated water, or other products or services, such as optical fiber, cable, electrical, etc., or a combination of various fluids and other products or services. Each of the plurality of pipes 56a isolates the various water types from one another as well as the wastewater and isolates the optical fiber from water.

Referring to FIG. 5, another embodiment of a fluid distribution apparatus 10b is shown. The fluid distribution apparatus 10b includes a conduit 60 and a plurality of receptacles 32b. The conduit 60 of the fluid distribution apparatus 10b is used for distributing and collecting fluids and other products or services, such as treated wastewater, raw water, optical fiber, etc., or a combination of various fluids and other products or services. The conduit 60 includes an exterior 62, an interior passageway 64 and an interior sidewall 66. The plurality of receptacles 32b are integrally formed along the interior sidewall 66 of the conduit 60 such that the fluid is permitted to flow through the interior passageway 64 of the conduit 60. Each of the plurality of receptacles 32b has a passageway 54b extending therethrough. The passageway 54b of each of the receptacles 32b is sized and dimensioned to receive and support at least one pipe 56b having a smaller diameter than that of the diameter of each of the passageways 54b of each of the receptacles 32b. It should be understood that the plurality of receptacles 32b may be any size provided that the fluid distribution apparatus 10b functions as described herein. Although each of the plurality of receptacles 32b is shown herein to have a substantially cylindrical shape, it will be appreciated that each of the plurality of receptacles 32b may be constructed in a variety of different shapes so long as the plurality of receptacles 32b can accommodate at least one pipe 56b and function in accordance with the present invention. Suitable materials for construction of each of the plurality of receptacles 32b include polymeric materials such as PVC, metals such as aluminum, copper, steel, titanium, or alloys containing these metals, and composite materials which are capable of providing the desired strength and durability of the receptacle. It should be understood that although the plurality of receptacles 32b are shown formed in the interior of the conduit, it should be understood that each of the plurality of receptacles 32b may be adhesively connected or secured to the interior sidewall 66 of the conduit 60.

In use, the fluid distribution apparatus 10 is positioned within an existing wastewater collection conduit 12. The fluid distribution apparatus 10 is disposed at varying or uniform distances/locations along the conduit 12 of the existing wastewater collection system. The at least one stabilizing member 30 frictionally engages the sidewall 14 of the conduit 12. At least one pipe 56 is disposed into the at least one receptacle 32. The at least one pipe 56 extends along the conduit 12 and is operably connected to another system or an existing system so as to deliver other product, such as treated wastewater. The fluid distribution apparatus 10 allows wastewater treatment plants to reroute all or part of the treated wastewater back into the same existing lines that travel into the plant, thereby providing for reuse of treated wastewater on a large scale for watering grass, washing automobiles, irrigation, etc. In extremely drought-stricken or dry areas, the fluid distribution apparatus 10 may be used for delivery of treated storm water run-off, thereby repeatedly recycling needed water.

The fluid distribution apparatus 10b is disposed into an existing system by replacing existing pieces of conduit 12 in the collection system. The conduit 60 of the fluid distribution apparatus 10b has the same diameter as the existing conduit 12. The conduit 12 is removed and replaced with the conduit 60. The conduit 60 is connected into the remaining existing conduit 12 by welding or some other known method for connecting one thing to another. The plurality of pipes 56b are disposed into the receptacles 32b for delivering various products, such as raw water, optical fibers, treated wastewater, and the like.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

1. A fluid distribution apparatus in combination with an existing conduit, the conduit being part of a fluid collection system and having a sidewall defining an interior passageway, the fluid distribution apparatus comprising:
at least one stabilizing member positioned in the interior passageway of the existing conduit and frictionally engaging the sidewall thereof, the at least one stabilizing member having a sidewall with a first end and a second end, the sidewall having a substantially-constant cross-section and being substantially incompressible along a longitudinal axis thereof, the first end and the second end being spaced apart from one another and the sidewall extending from the first end to the second end greater than 180 degrees about the conduit such that at least part of a lowermost portion of the conduit is unobstructed by the at least one stabilizing member; and
at least one receptacle supported by the stabilizing member, the at least one receptacle having at least one passageway extending therethrough, the at least one passageway sized and dimensioned to receive at least one pipe while permitting fluid to flow through the interior passageway of the existing conduit.

2-3. (canceled)

4. The fluid distribution apparatus of claim 1 wherein the at least one receptacle is cylindrically shaped.

5. The fluid distribution apparatus of claim 1 wherein the at least one receptacle is adhesively connected to the at least one stabilizing member.

6. The fluid distribution apparatus of claim 1 wherein the at least one receptacle is integrally formed with the at least one stabilizing member.

7-13. (canceled)

14. A method for forming a fluid distribution apparatus in an existing fluid collection system, the method comprising the steps of:
providing a fluid distribution apparatus, the fluid distribution apparatus comprising:
at least one stabilizing member having a sidewall with a first end and a second end, the sidewall having a substantially-constant cross-section and being substantially incompressible along a longitudinal axis thereof, the first end and the second end being spaced apart from one another and the sidewall extending from the first end to the second end greater than 180 degrees about the conduit such that at least part of a lowermost portion of the conduit is unobstructed by the at least one stabilizing member; and
at least one receptacle supported by the stabilizing member, the at least one receptacle having at least one passageway extending therethrough, the at least one passageway sized and dimensioned to receive at least one pipe while permitting fluid to flow through the interior passageway of the existing conduit;
inserting the fluid distribution apparatus into an existing conduit of the existing fluid collection system with the space between the first end and the second end of the stabilizing member maintained in a downwardly oriented position, the existing conduit having a sidewall defining an interior passageway extending through the existing conduit;
allowing the sidewall of the stabilizing member of the fluid distribution apparatus to frictionally engage at least a portion of the sidewall of the existing conduit; and
disposing at least one pipe into the at least one passageway of the at least one receptacle of the fluid distribution apparatus.
